(19) United States
(12) Patent Application Publication
(10) Pub. No.: US 2026/0069094 A1
(43) Pub. Date: Mar. 12, 2026

(54) Vacuum Cleaner Suction Tube Nozzle

(71) Applicant: LG Ventures UG (haftungsbeschränkt), Mainz (DE)

(72) Inventor: Christian Lang, Mainz (DE)

(21) Appl. No.: 19/388,496

(22) Filed: Nov. 13, 2025

Related U.S. Application Data
(63) Continuation of application No. PCT/EP2024/062956, filed on May 10, 2024.

(30) Foreign Application Priority Data
May 16, 2023 (EP) 23173574.7

(51) Int. Cl. A47L 7/00; A01M 3/00; A47L 9/24

(52) U.S. Cl. CPC A47L 7/009; A01M 3/005; A47L 9/242; A47L 9/248; A01M 2200/01

(57) ABSTRACT

A suction tube nozzle comprising at least a conduit with an inlet, an outlet and a conduit wall enclosing a conduit volume. conduit wall has a first end defining the inlet and a second end defining the outlet and an inner wall surface. The second end is configured to be connected to a distal end of a suction tube to thereby provide a fluid communication between the inlet and the suction tube. Insects sucked into the inlet are reliably cut in pieces if a first rotary bearing with a first rotational axis movably supports at least one first rotary blade inside the conduit volume relative to the conduit wall.

### BACKGROUND

### 1. Field of the Invention

The invention relates to a suction pipe nozzle for/of a vacuum cleaner. The suction pipe nozzle includes a conduit with a first end. The first end may be configured to be connected to the free end of a suction tube of a vacuum cleaner. The conduit further has a second end.

### 2. Description of the Related Art

Vacuum cleaners are known in the art and used in many households. One generally distinguishes cylinder vacuum cleaners, stick vacuum cleaner, upright vacuum cleaners and vacuum cleaner robots. Except of vacuum cleaner robots, the other types generally have a suction tube with a distal end (the end that points away from the user). Usually, a replaceable nozzle is attached to the distal end during cleaning. Dirt, dust, and the like (jointly “dirt” herein) is sucked via the nozzle into the suction tube and conveyed by an airflow to a dirt reservoir.

### SUMMARY OF THE INVENTION

The invention is based on the observation that vacuum cleaners are often used to remove insects from places where they are considered disturbing. Some people suffer from insect phobia in general, or kinds thereof, e.g., arachnophobia and some of these fear that insects sucked in by a vacuum cleaner are not killed by the removal process but might be able to escape from the dirt reservoir.

The problem to be solved by the invention is to provide a device that reliably kills at least small insects, in particular small spiders.

Solutions of the problem are described in the independent claims. The dependent claims relate to further improvements of the invention.

A solution is provided by a suction tube nozzle or a suction tube extension for/of a suction tube of a vacuum cleaner. The suction tube nozzle or suction tube extension may be configured to be connected to the distal end of a suction tube of a vacuum cleaner. Hereinafter, we will not distinguish between a suction tube nozzle or a suction tube extension, both terms are used interchangeably, i.e., suction tube nozzle shall be understood as suction tube nozzle and/or suction tube nozzle extension and vice versa.

The suction tube nozzle may include a conduit having a conduit wall with an inlet opening (hereinafter “inlet”) and an outlet opening (hereinafter “outlet”). The conduit wall may enclose a conduit volume extending from the inlet to the outlet. The inlet and the outlet are thus in fluid communication via the conduit volume. The conduit wall has a first end that may define, e.g., by radially delimiting, the inlet and a second end that may define the outlet, e.g., by radially delimiting the outlet. This does not imply that the inlet and outlet are necessarily rotationally symmetric, but that the inlet and the outlet may be delimited by the conduit wall in a radial direction, i.e., in a direction that points radially away from a conduit axis, assuming the conduit is a straight conduit. If the conduit is not straight, the term conduit axis can be replaced by neutral axis. Herein, we will use the term longitudinal axis for conceptional simplicity. It is understood by a person of skill in the art that the term has to be replaced by a more suitable term if the conduit is not straight. The longitudinal axis may be understood as a line that extends from the center of the inlet to the center of the outlet, while being centered with respect to the contour of an inner surface of the conduit.

The second end may be configured to be connected to a distal end of a suction tube to thereby provide a fluid communication between the inlet and the suction tube.

If the conduit includes at least a first rotary bearing with a first rotational axis, which bearing movably supports at least a first rotary blade or a first set of rotary blades in the conduit volume relative to the conduit wall, this (these) rotary blade(s) may be driven to rotate relative to the conduit wall and cut insects sucked in via the inlet into pieces to thereby ensure that only dead insects leave the outlet. The risk of sucking living insects in a dirt reservoir of a vacuum cleaner no longer exists. Insects that have been sucked in via the suction tube nozzle may hence not “escape” from the dirt reservoir and cannot frighten or otherwise harm persons. Herein, we use the term first rotary blade only for conceptual simplicity. The first rotary blade may be a set of first rotary blades, wherein each rotary blade of the set may be configured to rotate with the same rotational speed as the other members of the set. For example, the members of the first set of rotary blades may be attached to a first hub.

In an example, the suction tube nozzle includes a second rotary blade or a second set of rotary blades being as well rotatably supported relative to the housing wall by the first rotary bearing and/or a second rotary bearing. The second rotary blade may include the second rotary bearing, which second rotary bearing may have a second rotational axis. At least one of the first rotary bearing and the second rotary bearing may movably support the second rotary blade inside the conduit volume relative to the conduit wall. Like the term first rotary blade shall be understood to mean one first rotary blade or a first set of rotary blades, the term “second rotary blade” shall be understood to mean one “second rotary blade or second set of rotary blades”. Again, a set of rotary blades may be driven or interconnected to rotate with the same rotational speed.

Preferably, the at least one first rotary blade may be a rotary turbine blade having a first direction of rotation based on an assumed gas flow from the inlet through the conduit volume towards the outlet. Thus, when attaching the suction tube nozzle to a suction tube of an operating vacuum cleaner, the airflow through the conduit volume drives the first rotary blade to rotate in the first direction. This keeps cost for the suction tube nozzle low, as no motors, gears or the like are required to operate the first rotary blade. Further, clutches or other means to avoid overstressing the drive train when an insect abruptly slows the rotating rotary blade down can be avoided as well.

The optional second rotary blade may be a rotary turbine blade having a second direction of rotation, based on an assumed gas flow from the inlet through the conduit volume towards the outlet. This second direction of rotation may be opposite to the first direction of rotation. Assuming the first rotary blade to be upstream of (i.e., closer to the inlet than) the second rotary blade, particles of an insect that are transported with the airflow have an angular moment pointing in the same direction as the angular momentum of the first rotary blade, because hitting an insect transfers a portion of the rotary blade's angular momentum onto the insect and/or its particles. The relative angular velocity of the second rotary blade to these insects/particles may hence be increased and lower mass particles are cut into pieces with a higher probability. In short, the risk that an insect ‘passes’ the suction tube nozzle without being killed is reduced by the second rotary blade rotating opposite to the first rotary blade. Only to avoid misunderstandings, the same technical effect can be observed in case the second rotary blade is located upstream of the first rotary blade. However, it is of course preferred that the first and the second rotary blades are downstream or upstream of the respective other second or first rotary blade.

As already apparent, the first rotational axis and the second rotational axis are preferably at least essentially identical and/or at least essentially parallel. This measure reduces the pressure gradient between the inlet and the outlet and further contributes to the technical effect of reducing the risk that an insect passes the sequence of rotary blades.

Preferably, the suction tube nozzle includes at least one static blade with at least a first and/or a second static cutting edge. In an example the first static cutting-edge faces towards a first rotary cutting edge of the first rotary blade and/or the second static cutting edge faces towards a second rotary cutting edge of the second rotary blade. Face towards each other shall herein be understood to the express that the first static cutting edge provides a (cutting) abutment for an insect being loaded by the first rotary cutting edge. The abutment does not need to prevent any movement, but instead the two cutting edges may form an angle relative to each other. In both cases, cutting insects transported by the airflow from the inlet to the outlet is enhanced. As already apparent, the optional static cutting edge(s) may complement the respective rotary cutting edge(s).

In an example, at least one static blade axially supports the first rotary blade and/or the second rotary blade. This measure provides a reduction of the manufacturing cost and at the same reduces the pressure gradient between the inlet and the outlet and avoids that insects may get stuck at support structures extending in the conduit volume to support the rotary blade(s). In an example, the static cutting edge of the at least one static blade provides an axial abutment supporting at least one rotary blade (of the above-mentioned rotary blades). Hence, in operation, the axially supported rotary blade may slide with its rotary cutting edge over the static cutting edge, thereby ensuring that any insect being in between of these cutting edges relatively moving towards each other is reliably cut by these cutting edges.

The at least one static blade may radially support the rotary bearing and/or defines a bearing surface of the rotary bearing. This measure further contributes to reducing manufacturing costs and the flow resistance of the suction tube nozzle.

An axle and/or a shaft may extend in the conduit volume. The axle may be radially and/or axially supported by at least one strut extending from the inner wall surface towards the rotational axis of the first rotational bearing and/or the second rotational. The at least one strut can be configured as one of the optional static blades explained above. In other words, at least one strut may be a static blade and/or at least one static blade may be a strut. Accordingly, at least one static blade may extend from the inner wall towards the longitudinal axis and support the axle and/or the shaft radially and/or axially.

The axle may rotatably support the first rotary blade and optionally the second rotary blade, e.g., by the respective rotary bearing. This is a very cost efficient and reliable measure to rotatably support one or more rotary blades in the conduit volume, independently from each other.

Alternatively, a shaft may be rotatably supported in the conduit volume by the first and/or the second rotational bearing and the first rotary blade and/or the second rotary blade may be mounted to the shaft.

The first rotary bearing and/or the second rotary bearing may be a first fluid bearing and/or a second fluid bearing, respectively. Such fluid bearings reduce wear and allow for very high rotational speeds of the correspondingly supported rotary blades.

Preferably, the first fluid bearing and/or the second fluid bearing may include a first gas inlet and/or a second gas inlet and a first gas outlet and/or a second gas outlet, respectively. The first gas inlet and/or the second gas inlet may preferably face towards the inlet of the conduit and the first gas outlet and/or the second gas outlet, respectively, may preferably face towards outlet of the conduit. In operation, the pressure gradient between the first gas inlet and/or the second gas inlet and the first gas outlet and/or the second gas outlet, respectively, provides for a gas flow through the respective fluid bearing. Hence, no additional gas source is required to provide the fluid flow being required to operate the fluid bearings.

At least one of the first rotary blade and/or the second rotary blade and/or the static blade and/or a strut may be located in between of the first gas inlet and the first gas outlet of the first fluid bearing and/or in between of the second gas inlet and the second gas outlet of the second fluid bearing. “in between” references to the respective axial position assuming the conduit to have a longitudinal axis. The blade(s) and/or the strut(s) provide for an increased pressure gradient between the respective gas inlet and gas outlet. Thereby, the gas flow through the fluid bearings is enhanced.

In another example, at least one of the rotational bearings may be a plain bearing. A first bearing surface may be attached and/or integrally formed by the first rotary blade and/or the second rotary blade. The complementary other bearing surface may be provided by the peripheral surface of the axle and/or the conduit's wall inner surface, i.e., the surface of the conduit wall that faces towards the longitudinal axis.

Herein, the term “connection” and the corresponding verb “to connect” shall be understood not only as a mechanical connection, but as well as function enhancing connection. For example, two conduits are connected with each other if the mechanical connection provides for a fluid communication between the two pipes. In the example of a suction pipe and a suction pipe nozzle, a connection of these two elements would allow to suck a fluid via the nozzle inlet into the suction pipe.

Further, as will become apparent below, an expression like b∈A, A={c, d, e, f} or simply b∈{c, d, e, f} indicates that be b can be selected as appropriate to take any value included in the set A.

### BRIEF DESCRIPTION OF THE DRAWINGS

In the following, the invention will be described by way of example, without limitation of the general inventive concept, on examples of embodiment and with reference to the drawings.

FIG. 1 shows a sketch of sectional view of an example suction tube nozzle,

FIG. 2 shows a sketch of cross sectional view the suction tube nozzle along plane A-A indicated in FIG. 1.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

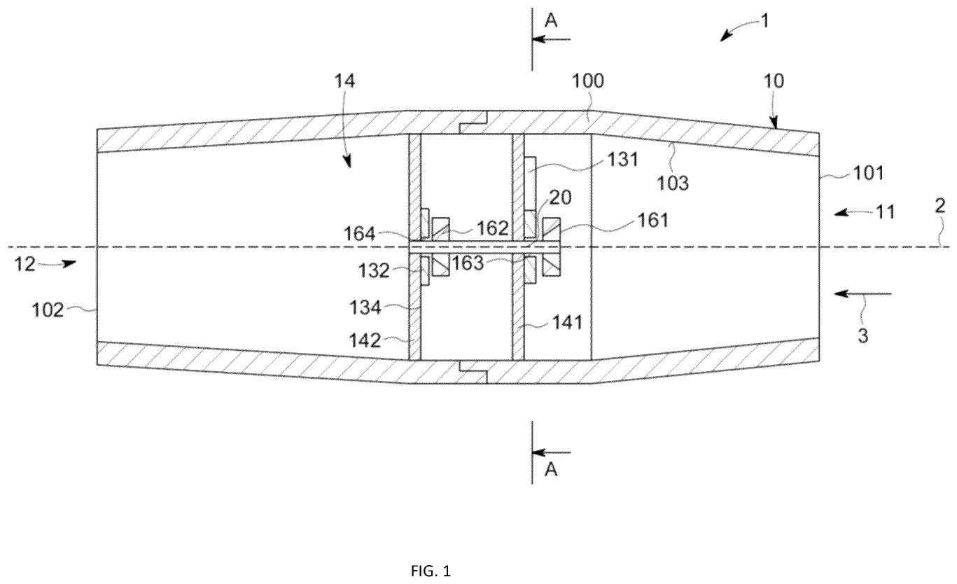

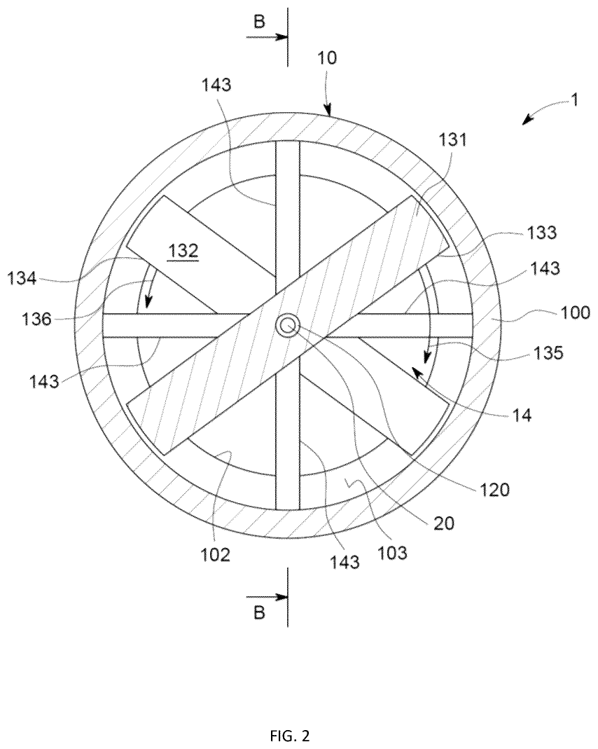

FIG. 1 shows a sketch of longitudinal section along plane B-B as indicated in FIG. 2 of an example suction tube nozzle 1. The suction tube nozzle 1 may include a conduit 10 with a longitudinal axis 2. The preferred flow direction is indicated by an arrow 3. The conduit 10 has a conduit wall 100 with an inner wall surface 103, a first end 101 and a second end 102. The first end 101 may radially delimit the inlet opening 11 (“inlet 11”) and the second end 102 may radially delimit the outlet opening 12 (“outlet 12”). The terms Inlet 11 and outlet 12 reference to the preferred flow direction 3.

A first set of static blades 141 may extend from the conduit wall 100 towards the longitudinal axis 2. In the example (see FIG. 2), four first static blades 141 are shown, but other integer numbers n₁( n₁∈{0, 1, 2, 3, 4, 5, 6, 7, . . . }) are possible as well. A second optional set of n₂ second static blades 142, i.e., a second set of static blades 142 may extend downstream of the first set of static blades 141 towards the longitudinal axis 2 (( n₂∈{0, 1, 2, 3, 4, 5, 6, 7, . . . })).

At least some of the static blades 141, 142, preferably all of them, support an axle 20. The axle 20 may be at least essentially aligned with preferred flow direction 3 and/or the longitudinal axis 2, as shown. “At least essentially aligned” shall indicate that a perfect alignment is preferred but that deviations from perfect alignment within an angle of ±α_{dev} can be accepted (α_{dev}∈{0°, 2.5°, 5°, 10°, 15°, 20°, 25°, 30°}, wherein smaller values of α_{dev} are preferred).

The axle 20 may rotatably support a first set of rotary blades 131 and/or a second set of rotary blades 132 by corresponding rotary bearings. As shown the two sets of rotary blades 131, 132 may be sets of turbine blades. The two sets of rotary blades 131, 132 may have opposite directions of rotation (see arrows 135, 136).

The bearings may be plain bearings, i.e., the peripheral surface of the axle 20 may form a first bearing surface and a recess in the respective set of rotary blades 131, 132 may provide as second plain bearing surface. Of course, the recess may as well be sleeved and in this case the sleeve may provide the respective bearing surface. Alternatively, the bearings may be fluid bearings with a gas inlet 161, 162 and a gas outlet 163, 164. Preferably, the gas inlet 161, 162 faces towards the inlet 11 of the conduit 10 and preferably the gas outlet 163, 164 faces in the opposite direction, wherein the gas inlet 161, 162 may be in fluid communication with the corresponding gas outlet 163, 154 via a moving gap between the respective rotary blade 131, 132 and the axle 20.

The rotary blades 131, 132 may have cutting edges 133, 134 (cf. FIG. 1 and FIG. 2). The cutting edges 133, 134 of the rotary blades 131, 132 may point in the rotational direction 135, 136 of the respective rotary blades 131, 132. The static blades 141, 142 may as well have cutting edges 143, which are preferably pointing in the opposite (rotational) direction than the cutting edges 133, 134 of the corresponding rotary blades 131, 132. In other words, a set of static blades 141,142 and a set of rotary blades 131, 132 may form a pair of interacting blades 131, 132, 141, 142 having cutting edges 133, 134, 143 that face towards each other. As can be seen when comparing FIG. 1 and FIG. 2, the cutting edge(s)s 133, 134 of the rotary blade(s) 131, 132 may contact the cutting edge(s) 143 of the corresponding static blade(s) 141, 142. Preferably, the static blades 141, 142 thereby provide an axial support of the corresponding rotary blade(s) 131, 132. This provides a scissor like cutting of insects entering the gap opening and closing between the corresponding cutting edges 133, 134, 143 due to the rotation of the rotary blades 131, 132.

It will be appreciated to those skilled in the art having the benefit of this disclosure that this invention is believed to provide a suction tube nozzle. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 suction tube nozzle
2 longitudinal axis
3 flow direction
10 conduit
11 conduit inlet
12 conduit outlet
14 conduit volume
20 axle
100 conduit wall
101 first end
102 second end
103 inner wall surface
120 rotary bearing
131 first rotary blade(s)
132 second rotary blade(s)
133 first cutting edge(s) of first rotary blade(s)
134 second cutting edge(s) of second rotary blade(s)
135 first rotational direction
136 second rotational direction
141 first static blade(s)
142 second static blade(s)
143 first static cutting edge(s)
144 second static cutting edge(s)
161 gas inlet
162 gas inlet
163 gas outlet
164 gas outlet

1-12. (canceled)

13. A suction tube nozzle comprising
at least a conduit with an inlet, an outlet and a conduit wall enclosing a conduit volume, wherein:
(i) the conduit wall has a first end and a second end and an inner wall surface,
(ii) the first end defines the inlet, and the second end defines the outlet, and
(iii) the second end is configured to be connected to a distal end of a suction tube to thereby provide a fluid communication between the inlet and the suction tube,
(iv) a first rotary bearing with a first rotational axis movably supports at least one first rotary blade inside the conduit volume relative to the conduit wall,
characterized in that
the suction tube nozzle further comprises a static blade with at least a first and/or a second static cutting edge, wherein the first static cutting edge faces towards a first rotary cutting edge of the first rotary blade and/or a second rotary cutting edge faces towards a static cutting edge of the second static blade.

14. The suction tube nozzle according to claim 13, wherein the suction tube nozzle further comprises a second rotary bearing with a second rotational axis, and that the second rotary bearing movably supports at least one second rotary blade inside the conduit volume relative to the conduit wall.

15. The suction tube nozzle according to claim 13, wherein the at least one first rotary blade is a turbine blade having a first rotational direction based on an assumed gas flow from the inlet through the conduit volume towards the outlet.

16. The suction tube nozzle according to claim 14, wherein the at least one second rotary blade has a second direction of rotation, based on an assumed gas flow from the inlet through the conduit volume towards the outlet and in that the second direction of rotation is opposite to the first direction of rotation.

17. The suction tube nozzle of claim 14, wherein the first rotational axis and the second rotational axis are identical.

18. The suction tube nozzle of claim 13, wherein the static blade axially supports the first rotary blade and/or a second rotary blade.

19. The suction tube nozzle of claim 13, wherein the static blade radially supports the first rotary bearing and/or defines a bearing surface of the first rotary bearing.

20. The suction tube nozzle of claim 14, wherein an axle extends in the conduit volume, wherein the axle is radially and/or axially supported by at least one strut extending from the inner wall surface towards the first rotational axis of the first rotary bearing and/or a rotational axis of a second rotary bearing, and in that the at least one first rotary blade (131) and the at least one second rotary blade are rotatably supported relative to the axle.

21. The suction tube nozzle of claim 14, wherein a shaft is rotatably supported in the conduit volume by the first rotary bearing and/or the second rotary bearing and in that the first rotary blade and the second rotary blade are mounted to the shaft.

22. The suction tube nozzle of claim 14, wherein the first rotary bearing and/or the second rotary bearing are a first fluid bearing and/or a second fluid bearing having a first gas inlet and/or second gas inlet, respectively, facing towards the inlet and a first gas outlet and/or a second gas outlet, respectively, facing towards the outlet.

23. The suction tube nozzle of claim 22, wherein the at least one of the first rotary blade and/or the at least one second rotary blade and/or the static blade are located in between a first gas inlet and a first gas outlet of a first gas bearing and/or in between a second gas inlet and a second gas outlet of a second gas bearing.
